(19) United States
(12) Patent Application Publication
(10) Pub. No.: US 2010/0002446 A1
(43) Pub. Date: Jan. 7, 2010

(54) XYZ control over bulb position in a pan and tilt lamp

(75) Inventor: James Bornhorst, De Soto, TX (US)

Correspondence Address: Law Office of Scott C Harris Inc, PO Box 1389, Rancho Santa Fe, CA, 92067, US

(73) Assignee: PRODUCTION RESOURCE GROUP L.L.C, New Windsor, NY (US)

(21) Appl. No.: 12/494,132

(22) Filed: Jun. 29, 2009

Related U.S. Application Data
(60) Provisional application No. 61/076,811, filed on Jun. 30, 2008.

(51) Int. Cl. F21V 7/00; F21V 21/06; H01J 9/00

(52) U.S. Cl. 362/296.01; 362/386; 445/1

(57) ABSTRACT

Multiple axis control for a lamp inside a reflector. At least multiple axes of control are made without increasing a length of the optical axis.

### BACKGROUND

Many modern lamps use a pinch style lamp inside a reflector. FIG. 1 shows an exemplary pinch style light lamp, or “lamp”. Other analogous lamps may have similar geometry and/or performance. This lamp 100 includes two pinches 110, 112 where the glass has been reduced in size and at least one of the pinches, here 110, may have one or more electrodes 114. Electrical connectors 104, 106 to the electrodes 114 may be on a mounting plate 102.

### SUMMARY

The present application teaches a way of fine controlling arc position in an arc lamp.

### BRIEF DESCRIPTION OF THE DRAWINGS

In the Drawings:

FIG. 1 shows a lamp in socket with a position adjust;

FIGS. 2A and 2B show a donut shaped socket and a lamp;

FIG. 3 shows a view of a second plate that holds the donut shaped socket;

FIG. 4 shows positioners for the lamp;

FIG. 5 illustrates the safety against lamp touching reflector;

FIG. 6 shows the z axis motion device; and

FIG. 7 shows an exploded view of all the parts.

### DETAILED DESCRIPTION

The term “lamp” is used herein to refer to the lamp that emits light.

The inventor noticed that the position of the arc 150 may differ from lamp to lamp. However, it is important that the arc 150 be perfectly aligned relative to the reflector 155 in order to get the best operation. For example, every reflector has a sweet spot from which the point of light should emanate. However, the inventor found in practice that lamps that are simply placed into the connectors such as 102 may have arcs or center points which differ in position.

In order to address this issue, x,y,z positioning is used for fine movement of an installed lamps in the x, y, and z directions.

In an embodiment, the reflector sweet spot will produce maximum light output when the lamp is placed within about a quarter millimeter of the desired location. Fine adjustment of the position of the lamp may therefore improve the accuracy of the projection.

However, even though the embodiment uses adjustment, it is undesirable to lengthen the overall light path that is used for the projection. The luminaires of the embodiments use a lamp that projects the light along a path. The path is formed by the positioning of the lamp, the reflector, and any other optical items that can be in the path of the light. These devices may include, for example, optical devices such as color changers, gobos, iris/shutter, zoom lenses, and any other devices that may change the light before it reaches its destination. In one embodiment, the luminaire may project light past these optical devices forming the optical train. The light projection axis is referred to herein as an optical axis.

All of these items can add to the length of the optical train, and hence can add to the length of the overall packaged luminaire.

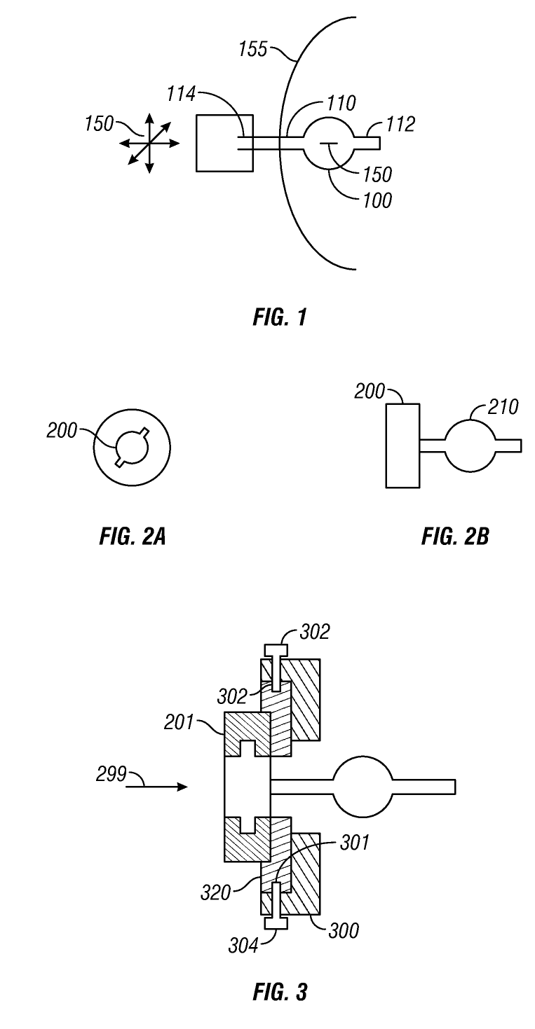

In the FIG. 1 embodiment, if an x,y,z positioner were put in the location 150 where the positioning arrows are shown, that positioner would be in the direction of the optical axis. It would hence lengthen the necessary length of the luminaire.

FIGS. 2A-2B show an embodiment using a lamp socket that adjusts the position of the lamp without lengthening the light length. FIG. 2A illustrates a doughnut shaped socket that goes over and surrounds at least a part of the connection part 102 and connects to the connectors 104. This socket does not add any length to the luminaire, since it connects concentric to the lamp 210, as shown in FIG. 2B. Therefore, the length of the socket, shown as L in FIG. 2B, goes around the lamp 210. This as compared with in front or back of the lamp 210 where it could add length to the lamp 210.

An embodiment adds a plate to that socket 200, also preferably concentric to the lamp. This first plate 320 shown in FIG. 3 is connected to the socket. The lamp 120 extends through a central hole 330 in the first plate 320. The first plate has shoulders 331 forming inner surfaces that fit over the outer surfaces 201 of the donut shaped first socket 200.

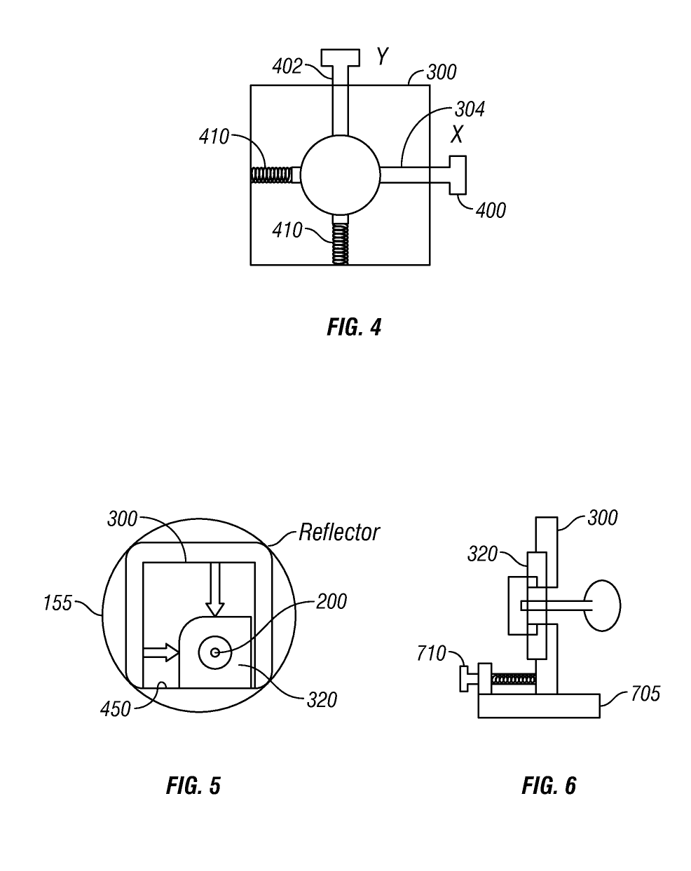

The plate 320 with the lamp therein is then held rigidly or “captured” by a second plate 300 that includes surfaces therein that hold the first plate 320. In an embodiment, the first plate 320 has openings 301, 302 therein spaced around the edges of the plate 320. Devices 304 are held on the second plate that hold into the first plate 320. These devices also form tensioners such as 304 on multiple sides, as shown in FIG. 4.

One or more of the tensioners may be screwed against the force of a spring. These tensioners hold the plate against movement, but can be adjusted to finely change the position of the socket, and hence change the position of the arc. FIG. 4 shows x and y tensioners 400, 402 which respectively control the x and y positions of the lamp. The x-tensioner 400 biases against a spring 410 which is oppositely located to the x tensioner. The y tensioner 402 analogously biases against a spring 412.

One advantage of this configuration is that it allows changing the lamp without removing the xyz positioners as would need to be done if the xyz positioners were in the linear path of the lamp (as shown in FIG. 1).

FIG. 1 illustrates how when the x,y,z changer is behind the lamp, it is in the linear path of the lamp, and also would need to be removed in order to change the lamp.

In FIG. 3, the lamp itself is to the rear in FIG. 3. Opening the back of the luminaire gives access to the area 299. This allows changing the lamp without changing the positioner.

The edges 450 of the outer plate 300 are larger than the edges of the smaller plate 320. The edges of the two plates are set in locations that make it impossible for the lamp 210 to touch a reflector no matter where the lamp is moved. FIG. 5 shows how these surfaces prevent the lamp from being moved enough to touch the reflector.

The plate assembly discussed above controls x and y positioning from an area that is concentric to the lamp.

The z axis position uses a separate assembly shown in FIG. 6 as 700. This may displace on a track on a linear bearing 705. An adjustment 710 for the linear bearing adjusts the z axis position. This allows for x, y and z control of the lamp.

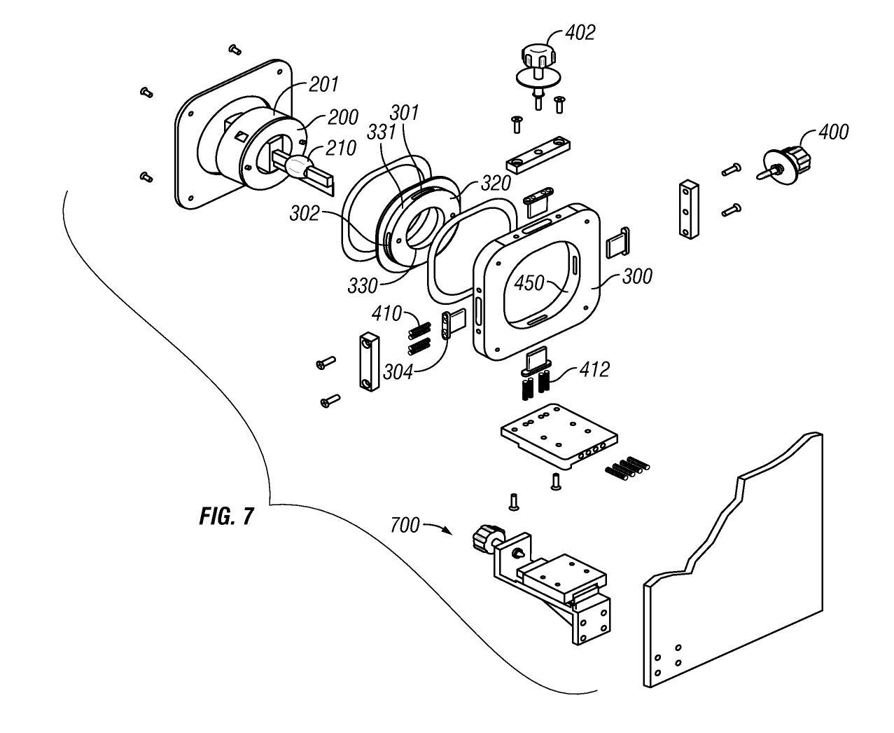

FIG. 7 shows an exploded view of all the parts and how they fit together. FIG. 7 shows that the z positioner 700 is located under the first plate 320 attached to the second plate 300, and moves the plates 300, 320 in that z direction. Again, this positioner does not add to the linear length of the luminaire.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other optical structures can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system comprising:
a socket for mounting a lamp; and
a fine position control for said lamp that is adjustable to control at least two orthogonal fine positions of said lamp without adding to a length of an optical axis along which light is produced.

2. A system as in claim 1, further comprising a reflector, surrounding said lamp.

3. A system as in claim 2, wherein said fine position control includes a safety device which prevents said lamp from touching said reflector.

4. A system as in claim 1, further comprising a third position changer, which changes a third orthogonal position of said lamp.

5. A system as in claim 1, wherein said fine position control includes a donut shaped part surrounding said lamp.

6. A system as in claim 5, further comprising a second plate that connects to said donut shaped part, said second plate including first and second positioners.

7. A system as in claim 6, wherein said positioners include spring-loaded screw parts.

8. A system as in claim 6, wherein said second plate includes a safety device which prevents said lamp from touching said reflector.

9. A method comprising:
mounting a lamp in a socket; and
adjusting a fine position control of said lamp in at least two orthogonal fine positions without adding to a length of an optical axis along which light is produced.

10. A method as in claim 9, further comprising using a reflector, to reflect light produced by said lamp.

11. A method as in claim 10, further comprising using a mechanism to prevent a lamp in said socket from touching said reflector.

12. A method as in claim 9, further comprising adjusting a third orthogonal position of said lamp.

13. A method as in claim 9, wherein said adjusting comprises surrounding a portion of said lamp with a donut shaped part that is fixed to said lamp.

14. A method as in claim 13, further comprising a second plate to said donut shaped part, said second plate including first and second positioners, and using said positioners to change a position of said lamp in said two orthogonal directions.

15. A method as in claim 14, further comprising using said second plate to mechanically prevent said lamp from touching said reflector.

16. A method comprising:
mounting a lamp in a socket; and
adjusting a fine position control of said lamp in at least two orthogonal fine positions using a position control; and
changing said lamp in said socket without removing said position control.

17. A method as in claim 16, further comprising using a reflector, to reflect light produced by said lamp.

18. A method as in claim 16, further comprising mechanically preventing said lamp from touching said reflector when adjusting using said fine position control.

19. A method as in claim 16, further comprising adjusting a third orthogonal position of said lamp.

20. A method comprising:
mounting a lamp in a socket;
mounting a reflector around said socket;
adjusting a fine position control of said lamp in at least two orthogonal fine positions using a position control, at least one of said fine positions being a position that could cause said lamp to contact said reflector; and
mechanically preventing movement of said lamp to a position that contacts said reflector.
